(19) United States
(12) Patent Application Publication
(10) Pub. No.: US 2025/0067854 A1
(43) Pub. Date: Feb. 27, 2025

(54) LiDAR LIGHT EMITTER REDUNDANCE

(71) Applicant: Continental Autonomous Mobility US, LLC, Aubum Hills, MI (US)

(72) Inventors: Jacob A. Bergam, Goleta, CA (US); Sebastian Heinz, Santa Barbara, CA (US); Elliot John Smith, Ventura, CA (US)

(73) Assignee: Continental Autonomous Mobility US, LLC, Auburn Hills, MI (US)

(21) Appl. No.: 18/237,290

(22) Filed: Aug. 23, 2023

(51) Int. Cl. G01S 7/497; G01S 7/484; G01S 17/931

(52) U.S. Cl. CPC G01S 7/497; G01S 7/484; G01S 17/931

(57) ABSTRACT

A controller for LiDAR sensor is programmed to activate a plurality of light emitter pairs each including a first light emitter and a second light emitter by alternating between a first powering sequence and a second powering sequence. The first powering sequence includes sequentially activating the first light emitters. The second powering sequence includes sequentially activating the second light emitters. The controller is programmed to, during one of the first powering sequences, detect damage to the first light emitter of a damaged one of the light emitter pairs. The controller is programmed to, during subsequent first powering sequences, activating the second light emitter of the damaged one of the light emitter pairs in response to detected damage to the first light emitter of the damaged one of the light emitter pairs.

### BACKGROUND

A solid-state LiDAR (Light Detection And Ranging) sensor includes a photodetector, or an array of photodetectors, that is fixed in place relative to a carrier, e.g., a vehicle. Light is emitted into the field of view of the photodetector and the photodetector detects light that is reflected by an object in the field of view, conceptually modeled as a packet of photons. For example, a Flash LiDAR sensor emits pulses of light, e.g., laser light, into the entire field of view. The detection of reflected light is used to generate a three-dimensional (3D) environmental map of the surrounding environment. The time of flight of reflected photons detected by the photodetector is used to determine the distance of the object that reflected the light.

The solid-state LiDAR sensor may be mounted on a vehicle to detect objects in the environment surrounding the vehicle and to detect distances of those objects for environmental mapping. The output of the solid-state LiDAR sensor may be used, for example, to autonomously or semi-autonomously control operation of the vehicle, e.g., propulsion, braking, steering, etc. Specifically, the sensor may be a component of or in communication with an advanced driver-assistance system (ADAS) of the vehicle.

A 3D map is generated a histogram of time of flight of reflected photons. Difficulties can arise in providing sufficient memory for calculating and storing histograms of the time of flights.

Challenges can arise in driving light emitters for a Flash LiDAR sensor in a way to provide sufficient power to obtain desired range information. In addition, if the light emitter of the LiDAR sensor is damaged, e.g., burns out, the LiDAR sensor may be inoperable.

### BRIEF DESCRIPTION OF THE DRAWINGS

FIG. 1 is a perspective view of a vehicle including a LiDAR sensor.

FIG. 2 is a perspective view of the LiDAR sensor.

FIG. 3 is a schematic side view of the LiDAR sensor.

FIG. 4 is a perspective view of a light sensor of the LiDAR sensor.

FIG. 4A is a magnified view of the light sensor schematically showing an array of photodetectors.

FIG. 5 is a block diagram of the LiDAR system.

FIG. 6 is a schematic illustration of a light array of the LiDAR sensor and a schematic representation of an example of powering sequences.

FIG. 7 is a schematic illustration of a light array of the LiDAR sensor and a schematic representation of another example of powering sequences.

FIG. 8 is a schematic of a light array of the LiDAR sensor and a schematic representation of an example of powering sequences in FIG. 7 after one of the light emitters is damaged.

FIG. 9A is a schematic of a light array of the LiDAR sensor, a schematic representation of an example powering sequence, and a schematic representation of an example shot sequence.

FIG. 9B is a schematic of a light array of the LiDAR sensor, a schematic representation of an example powering sequence, and a schematic representation of another example shot sequence.

FIG. 10A is a schematic illustration of the light array of the LiDAR sensor and example optics.

FIG. 10B is a schematic illustration of the light array of the LiDAR sensor and another example optics.

FIG. 11 is a schematic illustration of a plurality of drivers for the light array.

FIG. 12 is a schematic illustration of one driver that has a plurality of power banks for the light array.

FIGS. 13A and 13B are a flowchart illustrating an example method of operating the LiDAR sensor.

### DETAILED DESCRIPTION

With reference to the figures, wherein like numerals indicate like parts throughout the several views, a controller 24 for a LiDAR sensor 12 is programmed to activate a plurality of light emitter pairs 58 each including a first light emitter 60 and a second light emitter 62 by alternating between a first powering sequence and a second powering sequence. The first powering sequence includes sequentially activating the first light emitters 60. The second powering sequence includes sequentially activating the second light emitters 62. The controller 24 is programmed to, during one of the first powering sequences, detect damage to the first light emitter 60 of a damaged one of the light emitter pairs 58. The controller 24 is programmed to, during subsequent first powering sequences, activating the second light emitter 62 of the damaged one of the light emitter pairs 58 in response to detected damage to the first light emitter 60 of the damaged one of the light emitter pairs 58. With continued reference to the figures, the LiDAR sensor 12 is disclosed herein and a method of operating the LiDAR sensor 12 is disclosed herein.

The first powering sequence and the second powering sequence provide redundancy that allows for continued operation of the LiDAR sensor 12 even if one of the light emitters is damaged, e.g., burns out. Specifically, a damaged light emitter does not output light or outputs insufficient light when activated. The operation of the light emitters in the first powering sequence and the second powering sequence also increases the lifetime of the LiDAR sensor 12. Specifically, the total number of light emitters is increased by use of the first powering sequence and the second powering sequence. Since the LiDAR sensor 12 continues operation even after one or more of the light emitters is damaged,

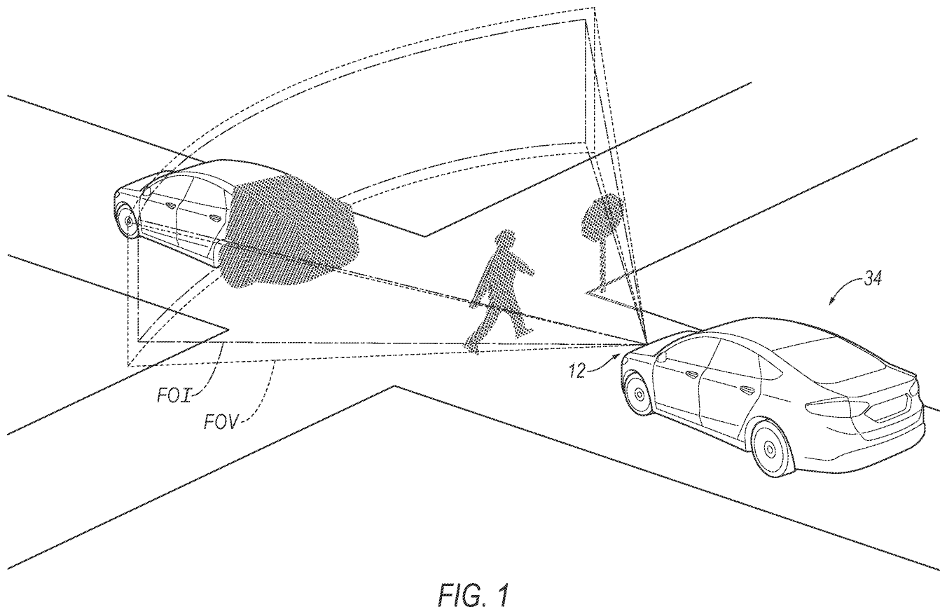

The LiDAR sensor 12 is shown in FIG. 1 as being mounted on a vehicle 34. In such an example, the LiDAR sensor 12 is operated to detect objects in the environment surrounding the vehicle (by both image detection by photodetectors 22 and by LiDAR detection by photodetector 22) and to detect distance, i.e., range, of those objects for environmental mapping (by LiDAR detection by photodetector 22). The output of the LiDAR sensor 12 (i.e., image detection and LiDAR detection) may be used, for example, to autonomously or semi-autonomously control operation of the vehicle 34, e.g., propulsion, braking, steering, etc. Specifically, the LiDAR sensor 12 may be a component of or in communication with an advanced driver-assistance system (ADAS) of the vehicle. The LiDAR sensor 12 may be mounted on the vehicle in any suitable position and aimed in any suitable direction. As one example, the LiDAR sensor 12 is shown on the front of the vehicle 34 and directed forward. The vehicle 34 may have more than one LiDAR sensor 12 and/or the vehicle may include other object detection systems, including other LiDAR systems. The vehicle 34 shown in the figures is a passenger automobile. As other examples, the vehicle may be of any suitable manned or un-manned type including a plane, satellite, drone, watercraft, etc.

The LiDAR sensor 12 may be a solid-state LiDAR. In such an example, the LiDAR sensor 12 is stationary relative to the vehicle in contrast to a mechanical LiDAR, also called a rotating LiDAR, that rotates 360 degrees. The solid-state LiDAR sensor 12, for example, may include a casing 36 that is fixed relative to the vehicle 34, i.e., does not move relative to the component of the vehicle 34 to which the casing 36 is attached, and components of the LiDAR sensor 12 are supported in the casing 36. As a solid-state LiDAR, the LiDAR sensor 12 may be a flash LiDAR system. In such an example, the LiDAR sensor 12 emits pulses, i.e., flashes, of light into a field of illumination FOI. More specifically, the LiDAR sensor 12 may be a 3D flash LiDAR system that generates a 3D environmental map of the surrounding environment. In a flash LiDAR system, the FOI illuminates a field of view FOV of the light sensor 20. Another example of solid-state LiDAR includes an optical-phase array (OPA). Another example of solid-state LiDAR is a micro-electromechanical system (MEMS) scanning LiDAR, which may also be referred to as a quasi-solid-state LiDAR.

The LiDAR sensor 12 emits infrared light and detects (i.e., with photodetectors 22) the emitted light that is reflected by an object in the field of view FOV, e.g., pedestrians, street signs, vehicles, etc. Specifically, the LiDAR sensor 12 includes a light-emission system 38, a light-receiving system 40, and a controller 24 that controls the light-emission system 38 and the light-receiving system 40. The LiDAR sensor 12 also detects ambient visible light reflected by an object in the field of view FOV (i.e., with photodetectors 22).

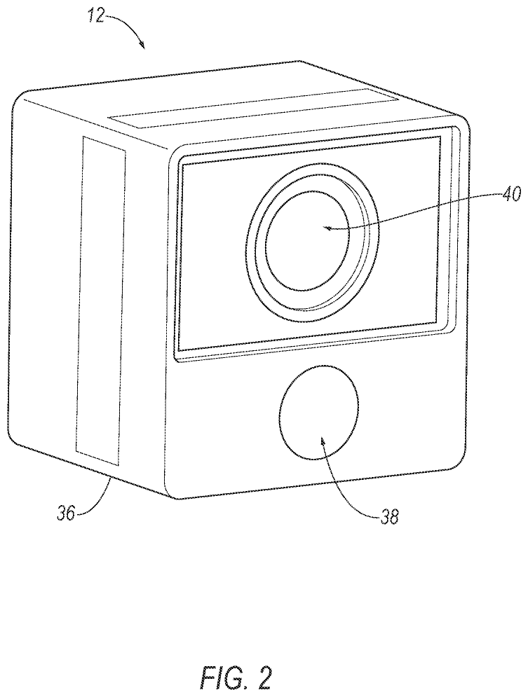

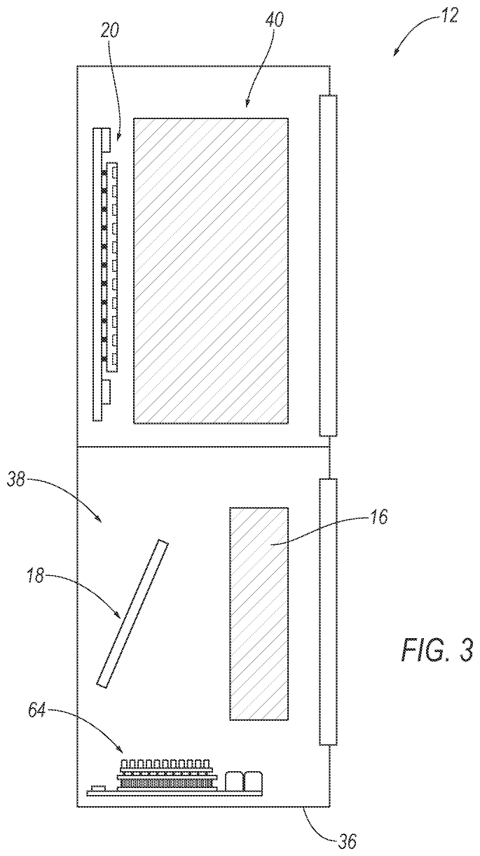

With reference to FIGS. 2-3, the LiDAR sensor 12 may be a unit. Specifically, the LiDAR sensor 12 may include a casing 36 that supports the light-emission system 38 and the light-receiving system 40. The casing 36 may enclose the light-emission system 38 and the light-receiving system 40. The casing 36 may include mechanical attachment features to attach the casing 36 to the vehicle and electronic connections to connect to and communicate with electronic system of the vehicle, e.g., components of the ADAS. The window extends through the casing 36. The window includes an aperture extending through the casing 36 and may include a lens or other optical device in the aperture. The casing 36, for example, may be plastic or metal and may protect the other components of the LiDAR sensor 12 from moisture, environmental precipitation, dust, etc. In the alternative to the LiDAR sensor 12 being a unit, components of the LiDAR sensor 12, e.g., the light-emission system 38 and the light-receiving system 40, may be separated and disposed at different locations of the vehicle.

With reference to FIG. 3, the light-emission system 38 may include one or more light emitter. Specifically, the light-emission system 38 includes a light array 64 including a plurality of light emitter pairs 58. Each light emitter pair 58 includes a first light emitter 60 and a second light emitter 62. In the example shown in the figures, the light array 64 includes two rows of light emitters (i.e. a row of first light emitters 60 and a row of second light emitters 62) arranged in a plurality of columns (i.e., with each column including one first light emitter 60 and one second light emitter 62). In other examples, the light array 64 may include any suitable number of rows and columns.

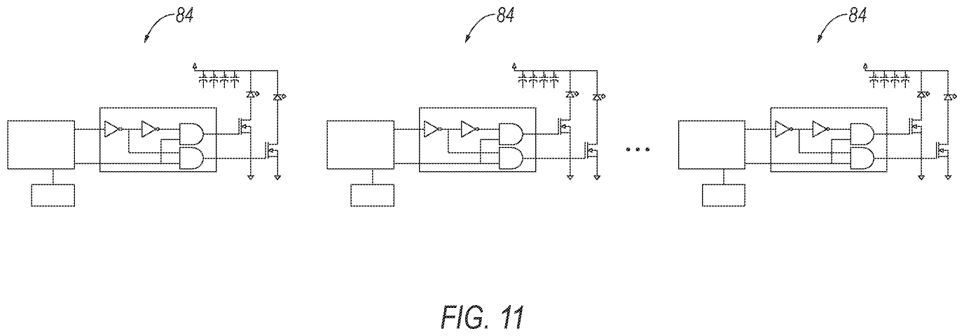

The light-emission system 38 may include optical components 16 such as a lens package, lens crystal, pump delivery optics, etc. The optical components 16, e.g., lens package, lens crystal, etc., are between the light array 64 and a window on the casing 36. Thus, light emitted from the light array 64 passes through the optical components 16 before exiting the casing 36 through the window. The optical components 16 may include an optical element, a collimating lens, transmission optics, etc. The optical components 16 direct, focuses, and/or shapes the light, etc. For example, the optical components 16 may include a lens 82 such as a diffuser, special light modulator, etc., as shown schematically in FIGS. 10A and 10B. As shown schematically in FIG. 10A, the optical components 16 may include a micro-lens array 80.

The light emitter emits light for illuminating objects for detection. The light-emission system 38 may include a beam-steering device 18 between the light emitter and the window. The controller 24 is in communication with the light emitter for controlling the emission of light from the light emitter and, in examples including a beam-steering device 18, the controller 24 is in communication with the beam-steering device 18 for aiming the emission of light from the LiDAR sensor 12 into the field of illumination FOI.

The light emitter emits light into the field of illumination FOI for detection by the light-receiving system 40 when the light is reflected by an object in the field of view FOV. The light emitter emits shots, i.e., pulses, of light into the field of illumination FOI for detection by the light-receiving system 40 when the light is reflected by an object in the field of view FOV to return photons to the light-receiving system 40. Specifically, the light emitter emits a series of shots. As an example, the series of shots may be 1,500-2,500 shots. The light-receiving system 40 has a field of view FOV that overlaps the field of illumination FOI and receives light reflected by surfaces of objects, buildings, road, etc., in the FOV. In other words, the light-receiving system 40 detects shots emitted from the light emitter and reflected in the field of view FOV back to the light-receiving system 40, i.e., detected shots. The light emitter may be in electrical communication with the controller 24, e.g., to provide the shots in response to commands from the controller 24.

Each light emitter (i.e., the first light emitters 60 and the second light emitters 62) may be, for example, a laser. The light emitter may be, for example, a semiconductor light emitter, e.g., laser diodes. In one example, the light emitter is a vertical-cavity surface-emitting laser (VCSEL). As another example, the light emitter may be a diode-pumped solid-state laser (DPSSL). As another example, the light emitter may be an edge emitting laser diode. The light emitter may be designed to emit a pulsed flash of light, e.g., a pulsed laser light. Specifically, the light emitter, e.g., the VCSEL or DPSSL or edge emitter, is designed to emit a pulsed laser light or train of laser light pulses. The light emitted by the light emitter may be, for example, infrared light. Alternatively, the light emitted by the light emitter may be of any suitable wavelength. The LiDAR sensor 12 may include any suitable number of light emitters, i.e., one or more in the casing 36. In examples that include more than one light emitter, the light emitters may be arranged in a column or in columns and rows. In examples that include more than one light emitter, the light emitters may be identical or different and may each be controlled by the controller 24 for operation individually and/or in unison. As set forth above, the light emitter may be aimed at an optical element. The light emitter may be aimed directly at the optical element or may be aimed indirectly at the optical element through intermediate components such as reflectors/deflectors, diffusers, optics, etc. The light emitter may be aimed at the beam-steering device 18 either directly or indirectly through intermediate components and the beam-steering device 18 aims the light from the light emitter, either directly or indirectly, to the lens. As one example, as shown schematically in FIG. 10A, the light emitters may generate individual fields of illumination FOI having different aim. In that example, the LiDAR sensor 12 includes a micro-lens array between the light emitters and a diffuser. As another example, as shown schematically in FIG. 10B, the light emitters may illuminate the same field of illumination FOI.

The light emitter may be stationary relative to the casing 36. In other words, the light emitter does not move relative to the casing 36 during operation of the LiDAR sensor 12, e.g., during light emission. The light emitter may be mounted to the casing 36 in any suitable fashion such that the light emitter and the casing 36 move together as a unit.

The light-receiving system 40 has a field of view FOV that overlaps the field of illumination FOI and receives light reflected by objects in the FOV. The light-receiving system 40 may include receiving optics and a light sensor 20 having the array of photodetectors 22. The light-receiving system 40 may include a receiving window and the receiving optics may be between the receiving window and the light sensor 20. The receiving optics may be of any suitable type and size.

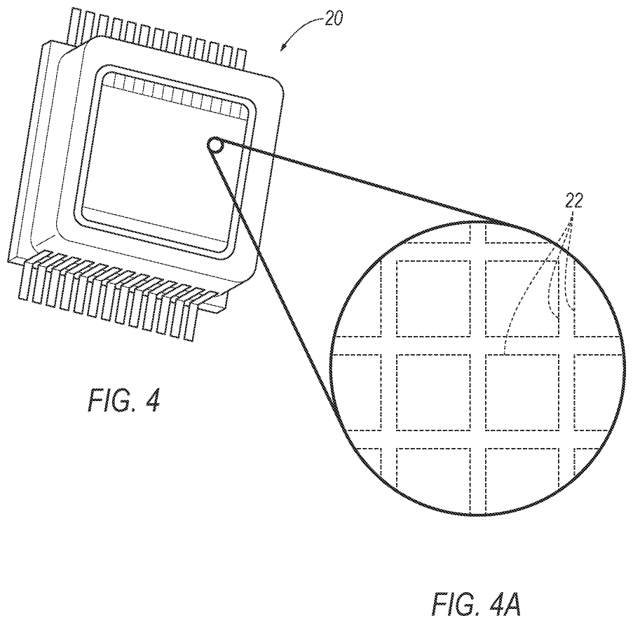

The light sensor 20 includes a chip and the array of photodetectors 22 is on the chip, as described further below. The chip may be silicon (Si), indium gallium arsenide (InGaAs), germanium (Ge), etc., as is known. The chip and the photodetectors 22 are shown schematically. The array of photodetectors 22 is 2-dimensional. Specifically, the array of photodetectors 22 includes a plurality of photodetectors 22 arranged in a columns and rows (schematically shown in FIGS. 4 and 4A).

Each photodetector 22 is light sensitive. Specifically, each photodetector 22 detects photons by photo-excitation of electric carriers. An output signal from the photodetector 22 indicates detection of light and may be proportional to the amount of detected light. The output signals of each photodetector 22 are collected to generate a scene detected by the photodetector 22.

The photodetector 22 may be of any suitable type, e.g., photodiodes (i.e., a semiconductor device having a p-n junction or a p-i-n junction) including avalanche photodiodes (APD), a single-photon avalanche diode (SPAD), a PIN diode, metal-semiconductor-metal photodetectors 22, phototransistors, photoconductive detectors, phototubes, photomultipliers, etc. The photodetectors 22 may each be of the same type.

Avalanche photo diodes (APD) are analog devices that output an analog signal, e.g., a current that is proportional to the light intensity incident on the detector. APDs have high dynamic range as a result but need to be backed by several additional analog circuits, such as a transconductance or transimpedance amplifier, a variable gain or differential amplifier, a high-speed A/D converter, one or more digital signal processors (DSPs) and the like.

In examples in which the photodetectors 22 are SPADs, the SPAD is a semiconductor device, specifically, an APD, having a p-n junction that is reverse biased (herein referred to as “bias”) at a voltage that exceeds the breakdown voltage of the p-n junction, i.e., in Geiger mode. The bias voltage is at a magnitude such that a single photon injected into the depletion layer triggers a self-sustaining avalanche, which produces a readily-detectable avalanche current. The leading edge of the avalanche current indicates the arrival time of the detected photon. In other words, the SPAD is a triggering device of which usually the leading edge determines the trigger.

The SPAD operates in Geiger mode. “Geiger mode” means that the APD is operated above the breakdown voltage of the semiconductor and a single electron-hole pair (generated by absorption of one photon) can trigger a strong avalanche. The SPAD is biased above its zero-frequency breakdown voltage to produce an average internal gain on the order of one million. Under such conditions, a readily-detectable avalanche current can be produced in response to a single input photon, thereby allowing the SPAD to be utilized to detect individual photons. “Avalanche breakdown” is a phenomenon that can occur in both insulating and semiconducting materials. It is a form of electric current multiplication that can allow very large currents within materials which are otherwise good insulators. It is a type of electron avalanche. In the present context, “gain” is a measure of an ability of a two-port circuit, e.g., the SPAD, to increase power or amplitude of a signal from the input to the output port.

When the SPAD is triggered in a Geiger-mode in response to a single input photon, the avalanche current continues as long as the bias voltage remains above the breakdown voltage of the SPAD. Thus, in order to detect the next photon, the avalanche current must be “quenched” and the SPAD must be reset. Quenching the avalanche current and resetting the SPAD involves a two-step process: (i) the bias voltage is reduced below the SPAD breakdown voltage to quench the avalanche current as rapidly as possible, and (ii) the SPAD bias is then raised by a power-supply circuit 44 to a voltage above the SPAD breakdown voltage so that the next photon can be detected.

Each photodetector 22 can output a count of incident photons, a time between incident photons, a time of incident photons (e.g., relative to an illumination output time), or other relevant data, and the LiDAR sensor 12 can transform these data into distances from the LiDAR sensor 12 to external surfaces in the field of view FOVs. By merging these distances with the position of photodetectors 22 at which these data originated and relative positions of these photodetectors 22 at a time that these data were collected, the LiDAR sensor 12 (or other device accessing these data) can reconstruct a three-dimensional (virtual or mathematical) model of a space occupied by the LiDAR sensor 12, such as in the form of 3D image represented by a rectangular matrix of range values, wherein each range value in the matrix corresponds to a polar coordinate in 3D space. Each photodetector 22 can be configured to detect a single photon per sampling period, e.g., in the example in which the photodetector 22 is a SPAD. The photodetector 22 functions to output a single signal or stream of signals corresponding to a count of photons incident on the photodetector 22 within one or more sampling periods. Each sampling period may be picoseconds, nanoseconds, microseconds, or milliseconds in duration. The photodetector 22 can output a count of incident photons, a time between incident photons, a time of incident photons (e.g., relative to an illumination output time), or other relevant data, and the LiDAR sensor 12 can transform these data into distances from the LiDAR sensor 12 to external surfaces in the fields of view of these photodetectors 22. By merging these distances with the position of photodetectors 22 at which these data originated and relative positions of these photodetectors 22 at a time that these data were collected, the controller 24 (or other device accessing these data) can reconstruct a three-dimensional 3D (virtual or mathematical) model of a space within FOV, such as in the form of 3D image represented by a rectangular matrix of range values, wherein each range value in the matrix corresponds to a polar coordinate in 3D space.

With reference to FIGS. 4 and 4A, the photodetectors 22 may be arranged as an array, e.g., a 2-dimensional arrangement. A 2D array of photodetectors 22 includes a plurality of photodetectors 22 arranged in columns and rows. Specifically, the light sensor 20 may be a focal-plane array (FPA).

The light sensor 20 includes a plurality of pixels. Each pixel may include one or more photodetectors 22. The pixels each including a power-supply circuit 44 and a read-out integrated circuit (ROIC 46). The photodetectors 22 are connected to the power-supply circuit 44 and the ROIC 46. Multiple pixels may share a common power-supply circuit 44 and/or ROIC 46.

The light sensor 20 detects photons by photo-excitation of electric carriers. An output from the light sensor 20 indicates a detection of light and may be proportional to the amount of detected light, in the case of a PIN diode or APD, and may be a digital signal in case of a SPAD. The outputs of light sensor 20 are collected to generate a 3D environmental map, e.g., 3D location coordinates of objects and surfaces within the field of view FOV of the LiDAR sensor 12.

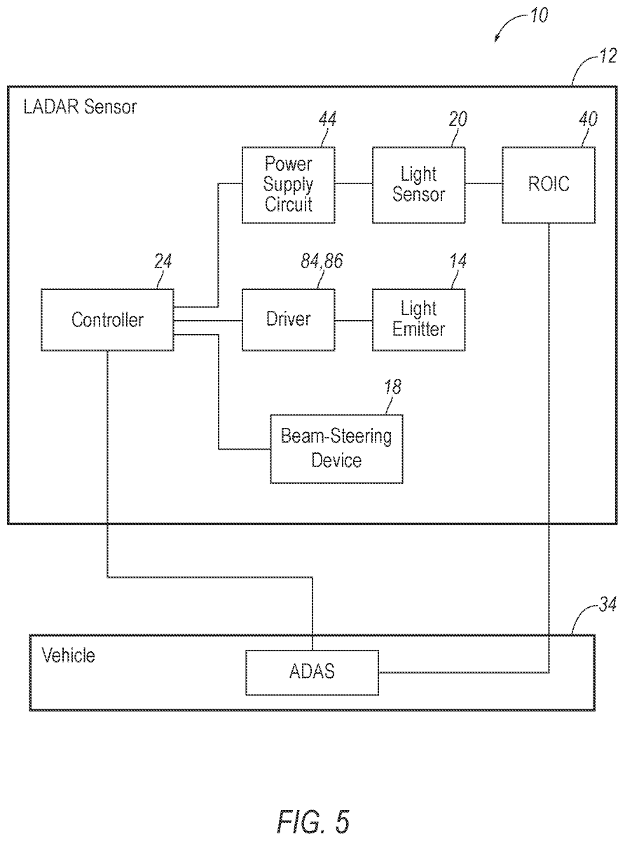

With reference to FIG. 5, the ROIC 46 converts an electrical signal received from photodetectors 22 of the FPA to digital signals. The ROIC 46 may include electrical components which can convert electrical voltage to digital data. The ROIC 46 may be connected to the controller 24, which receives the data from the ROIC 46 and may generate 3D environmental map based on the data received from the ROIC 46.

The power-supply circuits 44 supply power to the photodetectors 22. The power-supply circuit 44 may include active electrical components such as MOSFET (Metal-Oxide-Semiconductor Field-Effect Transistor), BiCMOS (Bipolar CMOS), etc., and passive components such as resistors, capacitors, etc. As an example, the power-supply circuit 44 may supply power to the photodetectors 22 in a first voltage range that is higher than a second operating voltage of the ROIC 46. The power-supply circuit 44 may receive timing information from the ROIC 46.

The light sensor 20 may include one or more circuits that generates a reference clock signal for operating the photodetectors 22. Additionally, the circuit may include logic circuits for actuating the photodetectors 22, power-supply circuit 44, ROIC 46, etc.

As set forth above, the light sensor 20 includes a power-supply circuit 44 that powers the pixels. The light sensor 20 may include a single power-supply circuit 44 in communication with all pixels or may include a plurality of power-supply circuits 44 in communication with a group 48 of the pixels.

The power-supply circuit 44 may include active electrical components such as MOSFET (Metal-Oxide-Semiconductor Field-Effect Transistor), BiCMOS (Bipolar CMOS), IGBT (Insulated-gate bipolar transistor), VMOS (vertical MOSFET), HexFET, DMOS (double-diffused MOSFET) LDMOS (lateral DMOS), BJT (Bipolar junction transistor), etc., and passive components such as resistors, capacitors, etc. The power-supply circuit 44 may include a power-supply control circuit. The power-supply control circuit may include electrical components such as a transistor, logical components, etc. The power-supply control circuit may control the power-supply circuit 44, e.g., in response to a command from the controller 24, to apply bias voltage and quench and reset the SPAD.

In examples in which the photodetector 22 is an avalanche-type photodiode, e.g., a SPAD, to control the power-supply circuit 44 to apply bias voltage, quench, and reset the avalanche-type diodes, the power-supply circuit 44 may include a power-supply control circuit. The power-supply control circuit may include electrical components such as a transistor, logical components, etc. A bias voltage, produced by the power-supply circuit 44, is applied to the cathode of the avalanche-type diode. An output of the avalanche-type diode, e.g., a voltage at a node, is measured by the ROIC 46 circuit to determine whether a photon is detected. The power-supply circuit 44 supplies the bias voltage to the avalanche-type diode based on inputs received from a driver circuit of the ROIC 46. The ROIC 46 may include the driver circuit to actuate the power-supply circuit 44, an analog-to-digital (ADC) or time-to-digital (TDC) circuit to measure an output of the avalanche-type diode at the node, and/or other electrical components such as volatile memory (register), and logical control circuits, etc. The driver circuit may be controlled based on an input received from the circuit of the light sensor 20, e.g., a reference clock. Data read by the ROIC 46 may be then stored in, for example, a memory chip. A controller 24, e.g., the controller 24, a controller 24 of the LiDAR sensor 12, etc., may receive the data from the memory chip and generate 3D environmental map, location coordinates of an object within the field of view FOV of the LiDAR sensor 12, etc.

The controller 24 actuates the power-supply circuit 44 to apply a bias voltage to the plurality of avalanche-type diodes. For example, the controller 24 may be programmed to actuate the ROIC 46 to send commands via the ROIC 46 driver to the power-supply circuit 44 to apply a bias voltage to individually powered avalanche-type diodes. Specifically, the controller 24 supplies bias voltage to avalanche-type diodes of the plurality of pixels of the focal-plane array through a plurality of the power-supply circuits 44, each power-supply circuit 44 dedicated to one of the pixels, as described above. The individual addressing of power to each pixel can also be used to compensate manufacturing variations via look-up-table programmed at an end-of-line testing station. The look-up-table may also be updated through periodic maintenance of the LiDAR sensor 12.

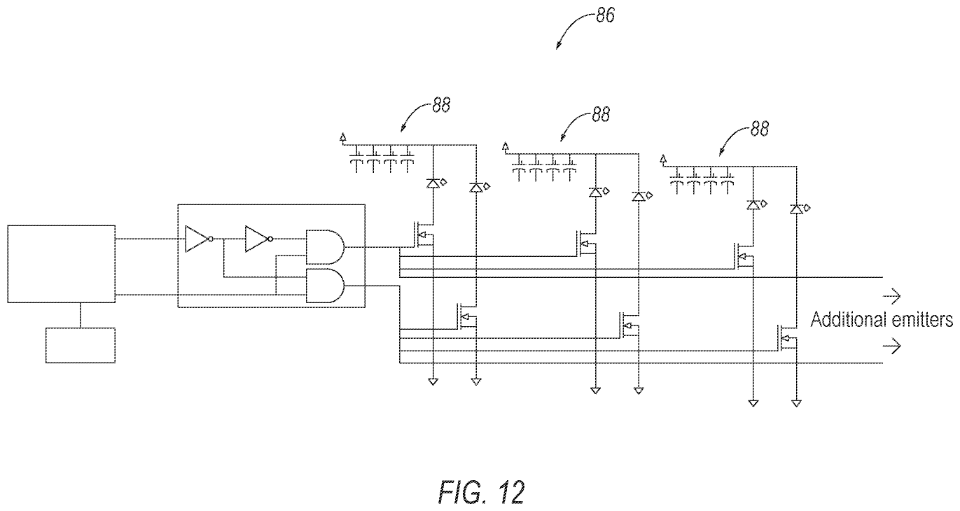

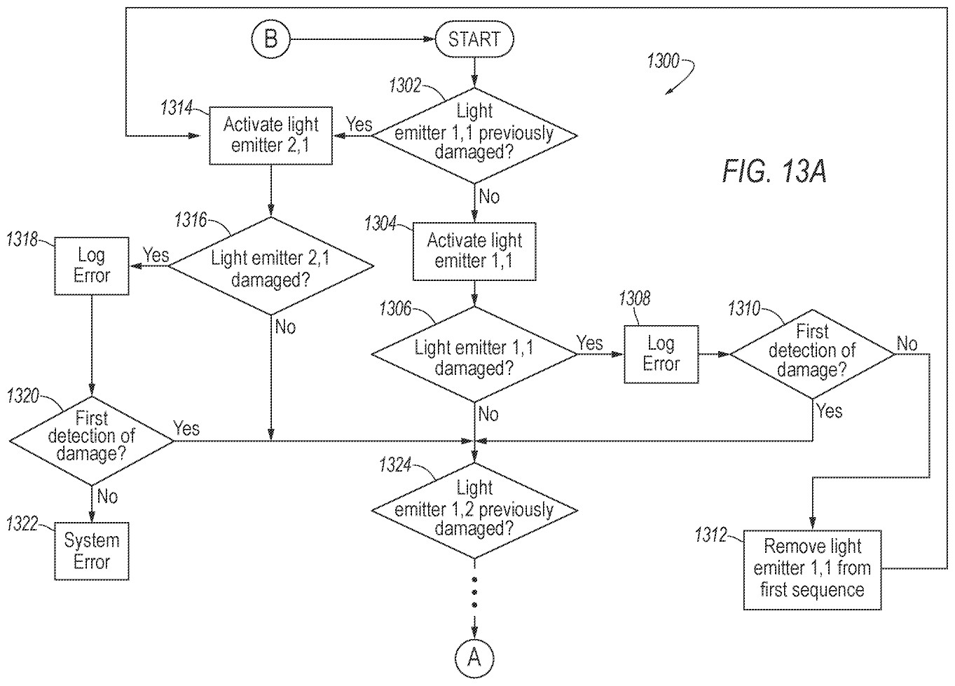

The controller 24 may include or control any suitable driver or combination of drivers to perform the first powering sequence and the second powering sequence. As an example, FIG. 11 is a schematic illustration of a plurality of drivers 84 each dedicated to one light emitter pair 58. As another example, FIG. 12 is a schematic illustration of one driver 86 that has a plurality of power banks 88 each dedicated to one light emitter pair 58.

The controller 24 is in electronic communication with the pixels (e.g., with the ROIC and power-supply circuit) and the vehicle 34 (e.g., with the ADAS) to receive data and transmit commands. The controller 24 may be configured to execute operations disclosed herein.

The controller 24 is a physical, i.e., structural, component of the LiDAR sensor 12. The controller 24 may be a microprocessor-based controller 24, an application specific integrated circuit (ASIC), field programmable gate array (FPGA), etc., or a combination thereof, implemented via circuits, chips, and/or other electronic components.

For example, the controller 24 may include a processor, memory, etc. In such an example, the memory of the controller 24 may store instructions executable by the processor, i.e., processor-executable instructions, and/or may store data. The memory includes one or more forms of controller-readable media, and stores instructions executable by the controller 24 for performing various operations, including as disclosed herein. As another example, the controller 24 may be or may include a dedicated electronic circuit including an ASIC (application specific integrated circuit) that is manufactured for a particular operation, e.g., calculating a histogram of data received from the LiDAR sensor 12 and/or generating a 3D environmental map for a field of view FOV of the light sensor and/or an image of the field of view FOV of the light sensor. As another example, the controller 24 may include an FPGA (field programmable gate array) which is an integrated circuit manufactured to be configurable by a customer. As an example, a hardware description language such as VHDL (very high speed integrated circuit hardware description language) is used in electronic design automation to describe digital and mixed-signal systems such as FPGA and ASIC. For example, an ASIC is manufactured based on hardware description language (e.g., VHDL programming) provided pre-manufacturing, and logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging. A controller 24 may be a set of controllers communicating with one another via a communication network of the vehicle, e.g., a controller in the LiDAR sensor 12 and a second controller in another location in the vehicle.

The controller 24 may be in communication with the communication network of the vehicle to send and/or receive instructions from the vehicle, e.g., components of the ADAS. The controller 24 is programmed to perform the method and function described herein and shown in the figures. For example, in an example including a processor and a memory, the instructions stored on the memory of the controller 24 include instructions to perform the method and function described herein and shown in the figures; in an example including an ASIC, the, the hardware description language (e.g., VHDL) and/or memory electrically connected to the circuit include instructions to perform the method and function described herein and shown in the figures; and in an example including an FPGA, the hardware description language (e.g., VHDL) and/or memory electrically connected to the circuit include instructions to perform the method and function described herein and shown in the figures. Use herein of “based on,” “in response to,” and “upon determining,” indicates a causal relationship, not merely a temporal relationship.

The controller 24 may provide data, e.g., a 3D environmental map and/or images, to the ADAS of the vehicle 34 and the ADAS may operate the vehicle in an autonomous or semi-autonomous mode based on the data from the controller 24. For purposes of this disclosure, an autonomous mode is defined as one in which each of vehicle propulsion, braking, and steering are controlled by the controller 24 and in a semi-autonomous mode the controller 24 controls one or two of vehicle propulsion, braking, and steering. In a non-autonomous mode a human operator controls each of vehicle propulsion, braking, and steering.

The controller 24 may include or be communicatively coupled to (e.g., through the communication network) more than one processor, e.g., controllers or the like included in the vehicle for monitoring and/or controlling various vehicle controllers, e.g., a powertrain controller, a brake controller, a steering controller, etc. The controller 24 is generally arranged for communications on a vehicle communication network that can include a bus in the vehicle such as a controller 24 area network (CAN) or the like, and/or other wired and/or wireless mechanisms.

The controller 24 is programmed to activate the light emitters, specifically the light emitter pairs 58, by alternating between the first powering sequence and the second powering sequence. In other words, the controller 24 performs the first powering sequence, and then the second powering sequence, and then the first powering sequence, and then the second powering sequence, and so on. The first powering sequence includes sequentially activating the first light emitters 60 and the second powering sequence includes sequentially activating the second light emitters 62. In other words, the first powering sequence includes activating one first light emitter 60 after another in a repeated order. Similarly, the second powering sequence includes activating one second light emitter 62 after another in a repeated order. All of the undamaged first light emitters 60 are activated during a complete first powering sequence and all of the undamaged second light emitters 62 are activated during a complete second powering sequence. As described herein, the first powering sequence and the second powering sequence may be altered in the instance that one of the light emitters is damaged, in which case that damaged light emitter is removed from the respective powering sequence. Specifically, in the event one of the first light emitters 60 is damaged, that first light emitter 60 is removed from the first powering sequence and in the event one of the second light emitters 62 is damaged, that second light emitter 62 is removed from the second powering sequence.

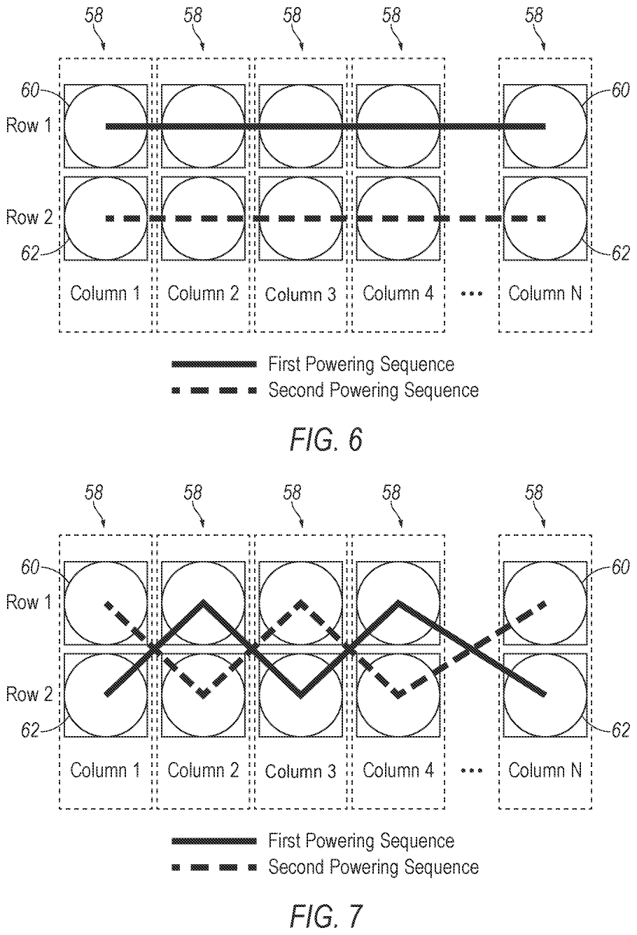

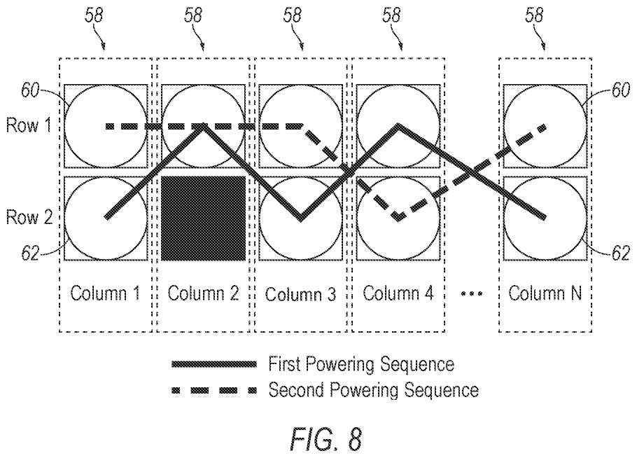

The first powering sequence and the second powering sequence may each follow repeating patterns, respectively, for undamaged light emitter pairs 58. Two examples of the pattern of the first powering sequence and the second powering sequence are shown in FIGS. 6 and 7 by way of non-limiting examples. In the example shown in FIG. 6, the first light emitters 60 are arranged in a row and the second light emitters 62 are arranged in a row. In that example, the first powering sequence moves across the row of first light emitters 60 and the second powering sequence moves across the row of second light emitters 62. In the example shown in FIG. 7, the first light emitters 60 and the second light emitters 62 alternate across each row and rows are offset. Specifically, across one row, the first light emitters 60 and the second light emitters 62 alternate and, across the other row, the first light emitters 60 and the second light emitters 62 alternate in a pattern offset from the other row. In both FIGS. 6 and 7, each light emitter pair 58 is arranged in a column. In FIG. 6, the first light emitters 60 are in the same row of each column and the second light emitters 62 are in the same row of each column. In FIG. 7, the first light emitters 60 alternate rows in adjacent columns and the second light emitters 62 alternate rows in adjacent columns.

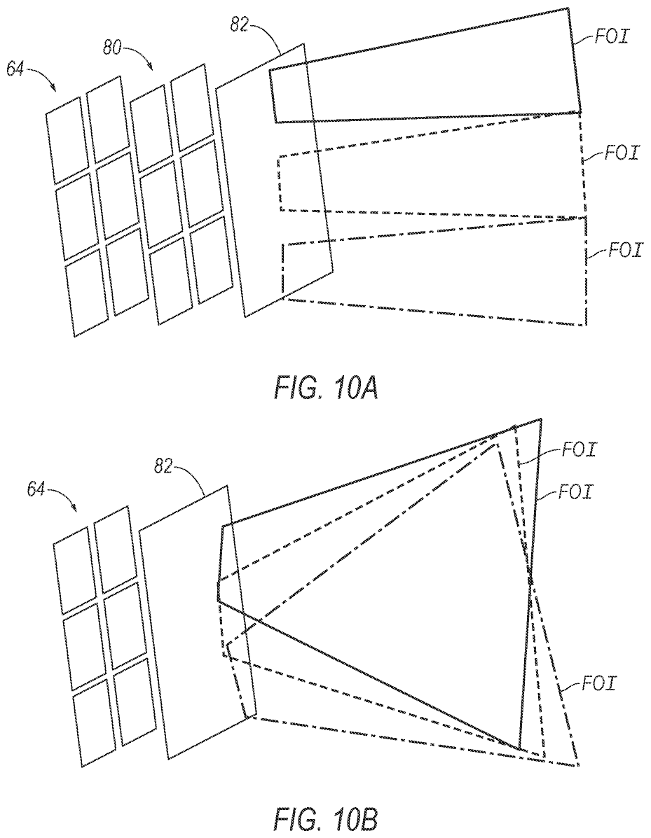

In some examples, such as the example shown in FIG. 9A, the controller 24 is programmed to interlace the first powering sequence and the second powering sequence with one another. In other words, a step of the first powering sequence is performed and the first powering sequence is interrupted without completing the first powering sequence, then a step of the second powering sequence is performed and the second powering sequence is interrupted without completing the second powering sequence, then the first powering sequence is resumed and a subsequent step of the first powering sequence is performed and the first powering sequence is interrupted without completing the first powering sequence, then the second powering sequence is resumed and a subsequent step of the second powering sequence is performed and the second powering sequence is interrupted, and so on.

In the example shown in FIG. 9A, adjacent light emitter pairs 58 are consecutively activated, i.e., a first light emitter 60 pair 58 is activated, then an adjacent second light emitter 62 pair 58 is activated, then a third light emitter pair 58 is activated, and so on for all of the light emitter pairs 58. In that example, for undamaged light emitters, the first light emitter 60 of the first light emitter 60 pair 58 is activated (i.e., in the first powering sequence), then the second light emitter 62 of the first light emitter 60 pair 58 is activated (i.e., in the second powering sequence), then the first light emitter 60 in the second light emitter 62 pair 58 is activated (i.e., in the first powering sequence), then the second light emitter 62 in the second light emitter 62 pair 58 is activated (i.e., in the second powering sequence), and so on. FIG. 9A shows the controller 24 instructs the light emitters to interlace the first powering sequence and the second powering sequence on a shot-to-shot basis (with a shot being a shot of light resulting from activation of the light emitter). The shot-to-shot shot sequence is shown in FIG. 9A with the powering sequences of FIG. 7 and can similarly be applied to the powering sequence of FIG. 6.

In some examples, such as the example shown in FIG. 9B, the first powering sequence may be started and completed before moving to the next second powering sequence. In such an example, the second powering sequence is started and completed before moving to the next first powering sequence. Said differently, the controller 24 is programmed to, during each first powering sequence and before the next second powering sequence, activate all first light emitters 60 that are undamaged. In such an example, the controller 24 is programmed to, during each second powering sequence and before the next first powering sequence, activate all second light emitters 62 that are undamaged. In such an example, during the first powering sequence, all undamaged first light emitters 60 of the light array 64 are consecutively activated without activation of any second light emitter 62 and, during the second powering sequence, all undamaged second light emitters 62 of the light array 64 are consecutively activated without activation of any first light emitter 60. FIG. 9B shows the controller 24 instructs the light emitters to perform the first powering sequence and the second powering sequence on a frame-by-frame basis (with a frame being a group of shots). The frame-to-frame shot sequence is shown in FIG. 9B with the powering sequences of FIG. 7 and can similarly be applied to the powering sequence of FIG. 6.

The controller 24 may be programmed to consecutively activate adjacent ones of the undamaged first light emitters 60 during the first powering sequence and consecutively activate adjacent ones of the undamaged second light emitters 62 during the second powering sequence. In other words, the first powering sequence moves across the undamaged first light emitters 60 from one first light emitter 60 to an adjacent first light emitter 60, and so on. Similarly, the second powering sequence moves across the undamaged second light emitters 62 from one second light emitter 62 to an adjacent second light emitter 62, and so on. In the example shown in FIG. 6, adjacent first light emitters 60 are arranged in the same row and adjacent second light emitters 62 are arranged in the same row. In the example shown in FIG. 7, adjacent first light emitters 60 are in alternating rows and adjacent second light emitters 62 are in alternating rows. In other examples, the controller 24 may be programmed such that the first powering sequence jumps between first light emitters 60 that are spaced from each other, i.e., with one or more other first light emitter 60 therebetween. In such examples, the first powering sequence may activate all undamaged first light emitters 60 in a pattern repeated for all first powering sequences and the second powering sequence may activate all second light emitters 62 in a pattern repeated for all second powering sequences.

In the examples shown in the figures, the controller 24 is programmed to individually activate the light emitters so that only one light emitter is activated at one time. In other examples, the controller 24 may be programmed to simultaneously activate groups of emitters. For example, in a step of the first powering sequence, a group of first light emitters 60 (e.g., a group of adjacent first light emitters 60) may be simultaneously activated and in a step of the second powering sequence, a group of second light emitters 62 (e.g., a group of adjacent second light emitters 62) may be simultaneously activated.

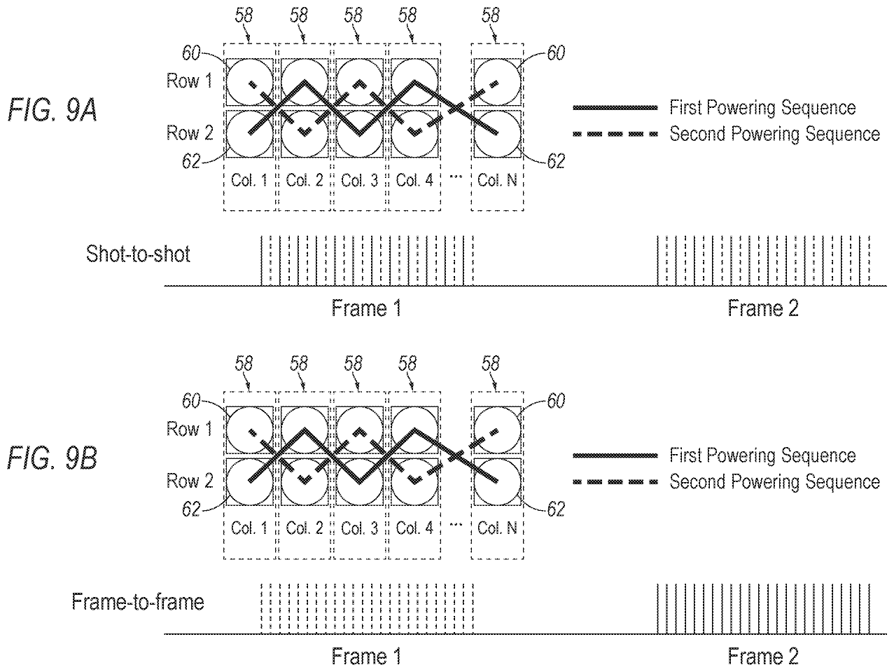

With reference to FIG. 8, the controller 24 is programmed to detect a damaged light emitter and to alter the corresponding powering sequence to avoid the damaged light emitter and instead activate the other light emitter of the pair. By way of example, damage to one of the first light emitters 60 is shown in the example in FIG. 8 and, as set forth above, the adjectives “first” and “second” are merely identifiers and do not indicate order or importance.

With continued reference to FIG. 8, one of the light emitter pairs 58 is damaged, specifically, the first light emitter 60 is damaged and the second light emitter 62 is not damaged. The controller 24 is programmed to, during one of the first powering sequences, detect damage to the first light emitter 60 of a damaged light emitter pair 58 (i.e., a light emitter pair 58 in which at least one of the light emitters 60, 62 is damaged). In that example, in response to detection of damage to the first light emitter 60, the second light emitter 62 of the damaged light emitter pair 58 is activated in that instance of the first powering sequence. Further, during subsequent first powering sequences, the controller 24 is programmed to power the second light emitter 62 of the damaged light emitter pair 58 in response to the detected damage to the first light emitter 60 of the damaged light emitter pair 58. In such an example, the controller 24 is programmed to, subsequent to the detection of damage to the first light emitter 60, activate the second light emitter 62 of the damaged light emitter pair 58 in both the first powering sequence and the second powering sequence.

In the event the second light emitter 62 of the damaged light emitter pair 58 is also damaged in addition to the first light emitter 60, the controller 24 is programmed to detect that damage to the second light emitter 62. Specifically, the controller 24 is programmed to detect damage to the second light emitter 62 of the damaged light emitter pair 58 in the same first power sequence in which the damage to the damaged first light emitter 60 was detected or during one of the subsequent second power sequences. In response to detection that both the first light emitter 60 and the second light emitter 62 of the same light emitter pair 58 are damaged, the controller 24 is programmed to identify a system error. In response to a system error, the LiDAR sensor 12 may continue to operate and accommodate for the damaged light emitter pair 58 or the LiDAR sensor 12 may cease operation and send an error code to the ADAS.

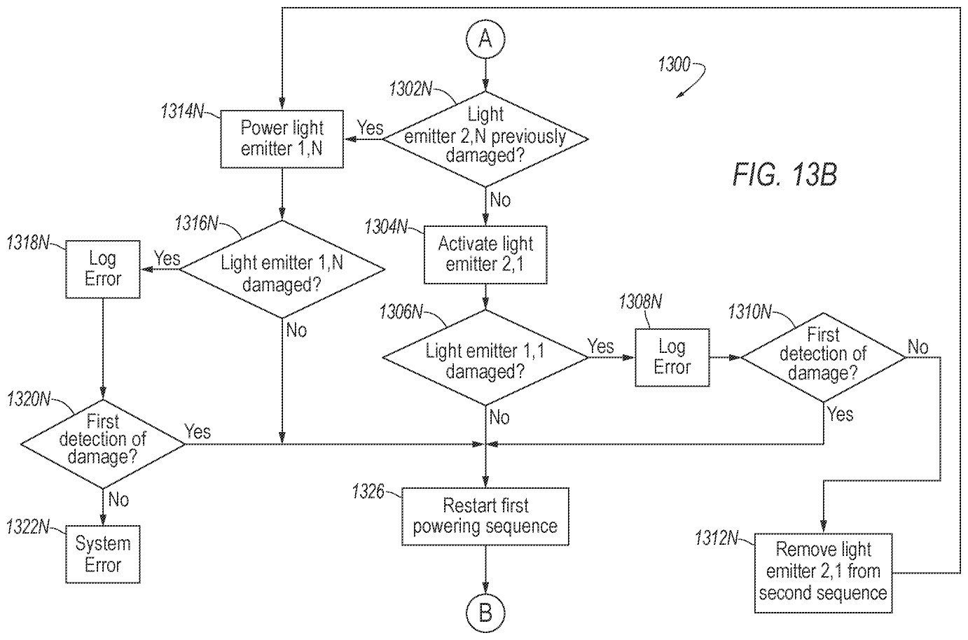

An example method 1300 is shown in FIGS. 13A and 13B. As set forth above, the controller 24 is programmed to perform the method 1300. The method 1300 includes repeatedly and alternatingly performing the first powering sequence and the second powering sequence. The method includes activating a light sensor 20 to detect light from the first light emitters 60 and the second light emitters 62 that is reflected by an object in a field of view FOV of the light sensor 20. Based on detected light, the method includes generating a scene, as described above.

FIGS. 13A and 13B illustrate merely one example method of operating the LiDAR sensor 12 and the present disclosure. The method 1300 is a method, for example, of operating the first powering sequence and the second powering sequence shown in FIG. 6. It should be appreciated that the method blocks shown in FIGS. 13A and 13B may be adjusted to similarly operate the first powering sequence and the second powering sequence shown in FIGS. 7, 9A, 9B, and all other powering sequences disclosed herein.

The method 1300 includes repeatedly alternating between the first powering sequence and the second powering sequence. The beginning of the first powering sequence is shown in FIG. 13A and the ending of the second powering sequence is shown in FIG. 13B. The ellipses between the first powering sequence and the second powering sequence in FIG. 13A indicate activating additional first light emitters 60 in the first powering sequence after the beginning of the first powering sequence shown in FIG. 13A followed by activating additional second light emitters 62 in the second powering sequence before the ending of the second powering sequence shown in FIG. 13B.

The method 1300 includes sequentially activating the first light emitters 60 in the first powering sequence and sequentially activating the second light emitters 62 in the second powering sequence. In other words, the first powering sequence includes activating one first light emitter 60 after another in a repeated order and the second powering sequence includes activating one second light emitter 62 after another in a repeated order. All of the undamaged first light emitters 60 are activated during a complete first powering sequence and all of the undamaged second light emitters 62 are activated during a complete second powering sequence. As described above, the first powering sequence and the second powering sequence may each follow repeating patterns, respectively, for undamaged light emitter pairs 58. The method may include interlacing the first powering sequence and the second powering sequence with one another or starting and completing the powering sequence before moving to the next powering sequence.

The method 1300 includes detecting damage to one of the light emitters of one of the light emitter pairs 58 and adjusting subsequent powering sequences to avoid attempting to activate the damaged light emitter. For example, the method 1300 includes during one instance of the first powering sequence, detecting damage to the first light emitter 60 of a damaged one of the light emitter pairs 58. In such an example, the method 1300 includes, during subsequent first powering sequences, activating the second light emitter 62 of the damaged light emitter pair 58 in response to detecting damage of the first light emitter 60 of the damaged light emitter pair 58. In other words, as a result of detecting damage of the first light emitter 60 of the damaged light emitter pair 58, the method 1300 activates the second light emitter 62 of the damaged light emitter pair 58 in subsequent first powering sequences. The method 1300 includes, during subsequent second powering sequences, activating the second light emitter 62 of the damaged light emitter pair 58. In other words, in such an example, the second light emitter 62 of the damaged light emitter pair 58 is activated in both the first powering sequence and the second powering sequence. In that example, the method 1300 includes, during the subsequent second power sequences, detecting damage to the second light emitter 62 of the damaged light emitter pair 58 and identifying a system error in response to detection of damage to the second light emitter 62 of the damaged one of the light emitter pairs 58. In response to a system error, the method 1300 may continue to operate and accommodate for the damaged light emitter pair 58 or the method 1300 may cease operation after sending an error code to the ADAS.

With reference to FIG. 13A, the method 1300 starts at decision block 1302. Block 1302 is the beginning of an instance of the first powering sequence. In this example, the method 1300 starts with attempted activation of the first light emitter 60 at the first row and first column of the light array 64, i.e., light emitter 1, 1. In block 1302, the method 1300 includes determining whether light emitter 1, 1 was previously damaged. Specifically, block 1302 determines whether an error has been logged (e.g., saved in memory of the controller 24 and/or otherwise recorded on the controller 24) in previous powering sequences indicating that light emitter 1, 1, is damaged. If light emitter 1, 1 had not been previously damaged, the method 1300 continues to block 1304 in which the method 1300 includes activating the light emitter 1, 1. In other words, the controller 24 provides power to the light emitter 1, 1. After activation of the light emitter 1, 1, the method 1300 proceeds to block 1306 in which the method 1300 includes determining if the light emitter 1, 1 is damaged. The method 1300 may determine whether the light emitter 1, 1 is damaged, for example, by detecting whether the current and/or voltage supplied to the light emitter 1, 1 when the light emitter 1, 1 was activated indicates that the light emitter 1,1 is damaged, i.e., with an expected current and/or voltage. If the light emitter 1, 1 is identified as undamaged in block 1306, the method 1300 proceeds to activation of the next light emitter, e.g., proceeds to block 1324 in the example of FIG. 13A.

If the light emitter 1, 1, is identified as damaged in block 1306, the method 1300 continues to block 1308 in which the error is logged. For example, the error may be saved in memory of the controller 24 and/or otherwise recorded on the controller 24. In decision block 1310, the method 1300 includes determining whether the detection of damage in block 1306 was the first detection of damage to that light emitter 1, 1. For example, this determination may be made by accessing previously logged errors. In the event the damage detected in block 1306 was the first detection of damage to that light emitter 1, 1, the method 1300 proceeds to activation of the next light emitter, e.g., proceeds to block 1324 in the example of FIG. 13A. In such an example, the first detection of damage may have been an erroneous determination and thus the error is logged and activation of that light emitter 1, 1 may be attempted in subsequent powering sequences.

In the event the detection of damage in block 1310 is not the first detection for that light emitter, the method 1300 includes removing that light emitter from the powering sequence. In the example shown in FIG. 13A, the method 1300 includes removing light emitter 1,1, from the first sequence in block 1312. Specifically, the light emitter may be removed from the powering sequence by saving the removal of that light emitter and adjustment of the first powering sequence on controller 24 (e.g., saved in memory of the controller 24 and/or otherwise recorded on the controller 24). When the light emitter of the damaged pair is removed from the powering sequence, that light emitter is replaced by the other undamaged light emitter in that light emitter pair 58 for subsequent powering sequences. In the example shown in FIG. 13A, the light emitter 1, 1 is removed from the first powering sequence in block 1312 and light emitter 2, 1 replaces light emitter 1, 1 in the first powering sequence, as described further below. In this example, light emitters 1, 1, and 2, 1 are a light emitter pair 58.

For example, in the example shown in FIG. 13A, the method 1300 proceeds from block 1312 to block 1314 in which the other light emitter in the light emitter pair 58 is activated. Specifically, in block 1314, the method 1300 includes activating the light emitter in the second row of the first column of the light array 64, i.e., light emitter 2, 1. In other words, the controller 24 provides power to the light emitter 2, 1. After activation of the light emitter 2, 1, the method 1300 proceeds to block 1316 in which the method 1300 includes determining if the light emitter 2, 1 is damaged. The method 1300 may determine whether the light emitter 2, 1 is damaged, for example, by detecting whether the current and/or voltage supplied to the light emitter 2, 1 when the light emitter 2, 1 was activated indicates that the light emitter 2, 1 is damaged, i.e., with an expected current and/or voltage. If the light emitter 2, 1 is identified as undamaged in block 1316, the method 1300 proceeds to activation of the next light emitter, e.g., proceeds to block 1324 in the example of FIG. 13A.

If the light emitter 2, 1, is identified as damaged in block 1316, the method 1300 continues to block 1318 in which the error is logged. For example, the error may be saved on the controller 24 (e.g., saved in memory of the controller 24 and/or otherwise recorded on the controller 24). In decision block 1320, the method 1300 includes determining whether the detection of damage in block 1316 was the first detection of damage to that light emitter 2, 1. For example, this determination may be made by accessing previously logged errors. In the event the damage detected in block 1306 was the first detection of damage to that light emitter 2, 1, the method 1300 proceeds to activation of the next light emitter, e.g., proceeds to block 1324 in the example of FIG. 13A. In such an example, the first detection of damage may have been an erroneous determination and thus the error is logged and activation of that light emitter 2, 1 may be attempted in subsequent powering sequences.

In the event the detection of damage in block 1320 is not the first detection for that light emitter 2, 1, the method 1300 includes identifying a system error in block 1322. Specifically, in the example shown in FIG. 13A, the method includes identifying the system error in response to detection of damage to the light emitter 2, 1. The system error indicates that both light emitters of a light emitter pair 58 are damaged, i.e., light emitter 1, 1 and light emitter 2, 1 in this example. In response to a system error, the method 1300 may continue to operate and accommodate for the damaged light emitter pair 58 or the method 1300 may cease operation after sending an error code to the ADAS.

In the example in FIG. 13A, blocks 1302-1322 are the first step of the first powering sequence. In block 1324 in FIG. 13A, the method 1300 proceeds to attempted operation of light emitter 1, 2, i.e., the light emitter at row 1, column 2 of the light array 64. In that example, light emitter 1, 2 is paired with light emitter 2, 2, as a light emitter pair 58. The ellipses after block 1324 indicate that the group of steps shown in blocks 1302-1322 are repeated, respectively, for light emitter 1, 2 and subsequent light emitters, i.e., to light emitter 1, N, in the first powering sequence. That instance of the first powering sequence is completed after light emitter 1, N. After the first powering sequence, the group of steps shown in blocks 1302-1322 are repeated, respectively, for light emitter 2, 1 to light emitter 2, N, which is the second powering sequence. Blocks 1302N-1322N, in FIG. 13B, show the last step of an instance of the second powering sequence. At the end of the second powering sequence, the method 1300 restarts at the first powering sequence, as shown in block 1326.

As set forth above, FIGS. 13A and 13B are an example of operating the first powering sequence and the second powering sequence shown in FIG. 6 with a frame-to-frame shot sequence. It should be appreciated that the method blocks shown in FIGS. 13A and 13B may be adjusted to similarly operate the first powering sequence and the second powering sequence shown in FIGS. 7. In FIGS. 13A and 13B, the method 1300 includes completing the first powering sequence for all first light emitters 60 (i.e., light emitter 1, 1 to light emitter 1, N) before proceeding to the second powering sequence. The second powering sequence is then completed for all of the second light emitters 62 (i.e., light emitter 2, 1 to light emitter 2, N) before proceeding to another instance of the second powering sequence. FIGS. 13A and 13B may be adjusted accordingly to accommodate for the order of light emitters for which activation is attempted and/or the order of the column/row of the attempted activation for the powering sequences shown in FIG. 7 and/or for a shot-to-shot shot sequence (an example of which is shown in FIG. 9A).

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

What is claimed is:

1. A method of operating a LiDAR sensor, the method comprising:
activating a plurality of light emitter pairs each including a first light emitter and a second light emitter by alternating between a first powering sequence and a second powering sequence;
the first powering sequence includes sequentially activating the first light emitters;
the second powering sequence includes sequentially activating the second light emitters;
during one of the first powering sequences, detecting damage to the first light emitter of a damaged one of the light emitter pairs; and
during subsequent first powering sequences, activating the second light emitter of the damaged one of the light emitter pairs in response to detected damage to the first light emitter of the damaged one of the light emitter pairs.

2. The method as set forth in claim 1, further comprising, during subsequent second powering sequences, activating the second light emitter of the damaged one of the light emitter pairs.

3. The method as set forth in claim 2, further comprising:
during the subsequent second power sequences, detecting damage to the second light emitter of the damaged one of the light emitter pairs; and
identifying a system error in response to detection of damage to the second light emitter of the damaged one of the light emitter pairs.

4. The method as set forth in claim 1, wherein all first light emitters that are undamaged are activated during the first powering sequences and before the next second powering sequence and all second light emitters that are undamaged are activated during the second powering sequence before the next first powering sequence.

5. The method as set forth in claim 4, wherein the adjacent ones of the first light emitters are consecutively activated during the first powering sequence and adjacent ones of the second light emitters are consecutively activated during the second powering sequence.

6. The method as set forth in claim 1, further comprising activating a light detector to detect light from the first and second light emitters that is reflected by an object in a field of view of the light detector.

7. A LIDAR sensor comprising:
a plurality of light emitter pairs, each light emitter pair including a first light emitter and a second light emitter; and
a controller programmed to:
activate the light emitter pairs by alternating between a first powering sequence and a second powering sequence;
the first powering sequence includes sequentially activating the first light emitters;
the second powering sequence includes sequentially activating the second light emitters;
during one of the first powering sequences, detect damage to the first light emitter of a damaged one of the light emitter pairs; and
during subsequent first powering sequences, powering the second light emitter of the damaged one of the light emitter pairs in response to detected damage to the first light emitter of the damaged one of the light emitter pairs.

8. The LiDAR sensor as set forth in claim 7, wherein the controller is programmed to, during subsequent second powering sequences, activate the second light emitter of the damaged one of the light emitter pairs.

9. The LiDAR sensor as set forth in claim 8, wherein the controller is programmed to:
during the subsequent second power sequences, detect damage to the second light emitter of the damaged one of the light emitter pairs; and
identify a system error in response to detection of damage to the second light emitter of the damaged one of the light emitter pairs.

10. The LiDAR sensor as set forth in claim 7, wherein the controller is programmed to, during each first powering sequence and before the next second powering sequence, activate all first light emitters that are undamaged and, during each second powering sequence and before the next first powering sequence, activate all second light emitters that are undamaged.

11. The LiDAR sensor as set forth in claim 10, wherein the controller is programmed to consecutively activate adjacent ones of the first light emitters during the first powering sequence and consecutively activate adjacent ones of the second light emitters during the second powering sequence.

12. The LiDAR sensor as set forth in claim 7, further comprising light detector configured to detect light from the first and second light emitters that is reflected by an object in a field of view of the light detector.

13. The LiDAR sensor as set forth in claim 7, wherein the controller is programmed by having a processor and memory storing instructions executable by the processor.

14. A controller for a LiDAR sensor, the controller programmed to:
activate a plurality of light emitter pairs each including a first light emitter and a second light emitter by alternating between a first powering sequence and a second powering sequence;
the first powering sequence includes sequentially activating the first light emitters;
the second powering sequence includes sequentially activating the second light emitters;
during one of the first powering sequences, detect damage to the first light emitter of a damaged one of the light emitter pairs; and
during subsequent first powering sequences, activating the second light emitter of the damaged one of the light emitter pairs in response to detected damage to the first light emitter of the damaged one of the light emitter pairs.

15. The controller as set forth in claim 14, further programmed to, during subsequent second powering sequences, activate the second light emitter of the damaged one of the light emitter pairs.

16. The controller as set forth in claim 15, further programmed to:
during the subsequent second power sequences, detect damage to the second light emitter of the damaged one of the light emitter pairs; and
identify a system error in response to detection of damage to the second light emitter of the damaged one of the light emitter pairs.

17. The controller as set forth in claim 14, further programmed to, during each first powering sequence and prior the next second powering sequence, activate all first light emitters that are undamaged and, during each second powering sequence and prior to the next first powering sequence, activate all second light emitters that are undamaged.

18. The controller as set forth in claim 17, further programmed to consecutively activate adjacent ones of the first light emitters during the first powering sequence and consecutively activate adjacent ones of the second light emitters during the second powering sequence.

19. The controller as set forth in claim 14, further comprising programming to activate a light detector configured to detect light from the first and second light emitters that is reflected by an object in a field of view of the light detector.

20. The controller as set forth in claim 14, wherein the controller is programmed by having a processor and memory storing instructions executable by the processor.
